(19) United States
(12) Patent Application Publication
(10) Pub. No.: US 2023/0103833 A1
(43) Pub. Date: Apr. 6, 2023

(54) PREDICTIVE ANOMALY DETECTION USING DEFINED INTERACTION LEVEL ANOMALY SCORES

(71) Applicant: UnitedHealth Group Incorporated, Minnetonka, MN (US)

(72) Inventors: Matthew H. Berls, Monroe, NJ (US); Matthew James Haberman, Golden Valley, MN (US); Hadi D. Halim, Kendall Park, NJ (US)

(21) Appl. No.: 17/486,272

(22) Filed: Sep. 27, 2021

(51) Int. Cl. G06N 5/02

(52) U.S. Cl. CPC G06N 5/022

(57) ABSTRACT

Various embodiments of the present invention provide methods, apparatus, systems, computing devices, computing entities, and/or the like for performing predictive anomaly detection. Certain embodiments of the present invention utilize systems, methods, and computer program products that perform predictive anomaly detection by utilizing at least one of defined interaction level anomaly scores, such as defined interaction level anomaly scores for non-constant defined interaction levels that are determined using weighted feature tuple anomaly scores for feature tuple values that are associated with the non-constant defined interaction levels, as well as defined interaction level anomaly scores for constant defined interaction levels that are determined using an anomaly distribution measure for an anomaly quantization metric across a plurality of inferred predictive entities.

### BACKGROUND

Various embodiments of the present invention address technical challenges related to performing predictive anomaly detection. Various embodiments of the present invention address the efficiency and reliability shortcomings of existing predictive anomaly detection solutions.

### BRIEF SUMMARY

In general, embodiments of the present invention provide methods, apparatus, systems, computing devices, computing entities, and/or the like for performing predictive anomaly detection. Certain embodiments of the present invention utilize systems, methods, and computer program products that perform predictive anomaly detection by utilizing at least one of defined interaction level anomaly scores, such as defined interaction level anomaly scores for non-constant defined interaction levels that are determined using weighted feature tuple anomaly scores for feature tuple values that are associated with the non-constant defined interaction levels, as well as defined interaction level anomaly scores for constant defined interaction levels that are determined using an anomaly distribution measure for an anomaly quantization metric across a plurality of inferred predictive entities.

In accordance with one aspect, a method is provided. In one embodiment, the method comprises: identifying a plurality of feature tuples for the predictive entity, wherein: (i) each feature tuple is associated with a defined interaction level of one or more non-constant defined interaction levels, , and (ii) each feature value count for a feature tuple is determined based at least in part on the non-constant defined interaction level that is associated with the feature tuple; for each feature tuple: determining a feature tuple anomaly score that describes an observed anomalous behavior measure associated with the feature tuple, identifying a feature tuple weight for the feature tuple that describes an estimated contribution of the feature tuple to the predicted anomaly score, and determining a weighted feature tuple anomaly score for the feature tuple based at least in part on the feature tuple anomaly score and the feature tuple weight; for each non-constant defined interaction level, determining a non-constant defined interaction level anomaly score based at least in part on each weighted feature tuple anomaly score that is associated with the non-constant defined interaction level; generating a predicted anomaly score based at least in part on each non-constant defined interaction level anomaly score; and performing one or more prediction-based actions based at least in part on the predicted anomaly score.

In accordance with another aspect, a computer program product is provided. The computer program product may comprise at least one computer-readable storage medium having computer-readable program code portions stored therein, the computer-readable program code portions comprising executable portions configured to: identify a plurality of feature tuples for the predictive entity, wherein: (i) each feature tuple is associated with a defined interaction level of one or more non-constant defined interaction levels, , and (ii) each feature value count for a feature tuple is determined based at least in part on the non-constant defined interaction level that is associated with the feature tuple; for each feature tuple: determine a feature tuple anomaly score that describes an observed anomalous behavior measure associated with the feature tuple, identify a feature tuple weight for the feature tuple that describes an estimated contribution of the feature tuple to the predicted anomaly score, and determine a weighted feature tuple anomaly score for the feature tuple based at least in part on the feature tuple anomaly score and the feature tuple weight; for each non-constant defined interaction level, determine a non-constant defined interaction level anomaly score based at least in part on each weighted feature tuple anomaly score that is associated with the non-constant defined interaction level; generate a predicted anomaly score based at least in part on each non-constant defined interaction level anomaly score; and perform one or more prediction-based actions based at least in part on the predicted anomaly score.

In accordance with yet another aspect, an apparatus comprising at least one processor and at least one memory including computer program code is provided. In one embodiment, the at least one memory and the computer program code may be configured to, with the processor, cause the apparatus to: identify a plurality of feature tuples for the predictive entity, wherein: (i) each feature tuple is associated with a defined interaction level of one or more non-constant defined interaction levels, , and (ii) each feature value count for a feature tuple is determined based at least in part on the non-constant defined interaction level that is associated with the feature tuple; for each feature tuple: determine a feature tuple anomaly score that describes an observed anomalous behavior measure associated with the feature tuple, identify a feature tuple weight for the feature tuple that describes an estimated contribution of the feature tuple to the predicted anomaly score, and determine a weighted feature tuple anomaly score for the feature tuple based at least in part on the feature tuple anomaly score and the feature tuple weight; for each non-constant defined interaction level, determine a non-constant defined interaction level anomaly score based at least in part on each weighted feature tuple anomaly score that is associated with the non-constant defined interaction level; generate a predicted anomaly score based at least in part on each non-constant defined interaction level anomaly score; and perform one or more prediction-based actions based at least in part on the predicted anomaly score.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a flowchart diagram of an example process for generating a predicted anomaly score for a predictive entity in accordance with some embodiments discussed herein.

FIG. 5 is a flowchart diagram of an example process for determining a defined interaction level anomaly score for a non-constant defined interaction level in accordance with some embodiments discussed herein.

FIG. 6 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Advantages

Various embodiments of the present invention introduce techniques for predictive anomaly detection that are able to efficiently and reliably generate predictive inferences across datasets/databases/tables in order to detect patterns of fraudulent activities that may be harder to detect using a single dataset/database/table. In doing so, various embodiments of the present invention enable cross-dataset/database/table inferences that do not require complex operations for cross-dataset/database/table correlations in order to generate training data for a predictive anomaly detection solution that is able to perform cross-dataset/database/table predictive anomaly detection inferences. In this way, various embodiments of the present invention address the efficiency and reliability shortcomings of existing predictive anomaly detection solutions and make important technical contribution to the fields of predictive data analysis and predictive anomaly detection.

For example, various embodiments of the present invention utilize systems, methods, and computer program products that perform predictive anomaly detection by utilizing at least one of defined interaction level anomaly scores, such as defined interaction level anomaly scores for non-constant defined interaction levels that are determined using weighted feature tuple anomaly scores for feature tuple values that are associated with the non-constant defined interaction levels, as well as defined interaction level anomaly scores for constant defined interaction levels that are determined using an anomaly distribution measure for an anomaly quantization metric across a plurality of inferred predictive entities. By utilizing the discussed techniques, various embodiments of the present invention enable cross-dataset/database/table inferences that do not require complex operations for cross-dataset/database/table correlations in order to generate training data for a predictive anomaly detection solution that is able to perform cross-dataset/database/table predictive anomaly detection inferences.

An exemplary application of various embodiments of the present invention relates to fraud, waste, and abuse (FWA) detection. In FWA investigations, a fraud actor often masquerades as “super entity” with multiple identifies. Currently, there is no way to see risk at this “super entity” level or at its individual component level. Various embodiments of the present invention resolve this linkage issue and create a traceable path to detecting super entities and thus enabling claim level tracing. Aspects of the present invention group multiple similar proxies into ensembles. Ensembles can be varied by what representation variable is used (e.g., a member may proxied by social security number, patient ID, demographic key, and/or the like) as well as central values used to represent a variable (e.g., count of investigation may be proxied by mean, median, total, and/or the like). Then, by using Taylor expansion, a proposed system can establish single variable ensembles, two variable ensembles, and/or the like.

Various embodiments of the present invention introduce techniques for generating feature value combinations in an hierarchical/ensemble that enable efficiently and effectively traversing a feature space. By using the noted techniques, various embodiments of the present invention enable making inferences about whether complex combinations of feature values can contribute to an FWA score, thus enabling performing sophisticated FWA prediction operations in a computationally efficient and operationally effective manner. In this way, various embodiments of the present invention make important technical contributions to the field of FWA predictive data analysis.

### II. Definitions

The term “feature value” may refer to a data entity that is configured to describe a feature value of a predictive entity. In some embodiments, the predictive entity may describe feature values of an entity (e.g., a real-world entity, a virtual entity, and/or the like) that may be used to generate a predicted anomaly score for the predictive entity. In one exemplary embodiment, the predictive entity may describe features of a suspected healthcare provider that is characterized by the noted feature values, such as at least one of a first Tax Identification Number (TIN) of the suspected healthcare provider as extracted from a first dataset/database/table, a second TIN of the suspected healthcare provider as extracted from a second dataset/database/table, a first national provider identifier (NPI) of the suspected healthcare provider as determined from the first dataset/database/table, a second NPI of the suspected healthcare provider as determined from a second dataset/database/table, a first social security number (SSN) of the suspected healthcare provider as determined from a third dataset/database/table, a second SSN of the suspected healthcare provider as determined from a fourth dataset/database/table. In some embodiments, a feature value comprises one or more first-level feature values (e.g., an ensemble feature value), one or more second-level feature values (e.g., an ensemble element feature value), one or more third-level features values (e.g., an ensemble element enumeration feature value), an anomaly quantization measure, and/or the like.

The term “feature tuple” may refer to a data entity that is configured to describe a combination of feature values of a predictive entity, where at least one of the feature values is selected from the input feature values for the predictive entity, and where the precise value ofp for a feature tuple defines the defined interaction level that is associated with the feature tuple. For example, with respect to a first-level defined interaction level that is associated with feature tuples having p = 1, the feature tuples of the first-level defined interaction level include singletons of feature values each comprising a single input feature value. As another example, with respect to a second-level defined interaction level that is associated with feature tuples having p = 2, the feature tuples of the second-level defined interaction include pairs of feature values. As yet another example, with respect to a second-level defined interaction level that is associated with feature tuples having p = 3, the feature tuples of the second-level defined interaction include triplets of feature values.

The term “defined interaction level” may refer to a data entity that is configured to describe a set of operations that are performed to generate a defined interaction level anomaly score that in turn can be used to generate a predicted anomaly score for a predictive entity. In some embodiments, generating a predicted anomaly score for a predictive entity comprises performing operations corresponding to a set of defined interaction levels, where each defined interaction level is associated with a level number, and where the level number for each non-constant defined interaction level describes a feature value count for (i.e., the number of feature values in feature tuples that are associated with) the feature tuples used as inputs to the non-constant defined interaction level. For example, in some embodiments, the non-constant defined interaction levels comprise a first-level defined interaction level that performs operations on feature tuples comprising singletons of feature values in order to generate a first-level defined interaction level anomaly score. As another example, in some embodiments, the non-constant defined interaction levels comprise a second-level defined interaction level that performs operations on feature tuples comprising pairs of feature values in order to generate a second-level defined interaction level anomaly score. As another example, in some embodiments, the non-constant defined interaction levels comprise a third-level defined interaction level that performs operations on feature tuples comprising triplets of feature values in order to generate a third-level defined interaction level anomaly score. In some embodiments, the constant defined interaction levels comprise a zeroth-level defined interaction level whose defined interaction level anomaly score is determined based at least in part on an anomaly distribution measure for an anomaly quantization metric across a plurality of inferred predictive entities, where the plurality of inferred predictive entities may be determined based at least in part on the one or more defined input feature values.

The term “non-constant defined interaction level” may refer to a data entity that is configured to describe a defined interaction level that is configured to generate a defined interaction level anomaly score based at least in part on feature tuples for a predictive entity. As described above, the level number of a non-constant defined interaction level may define the size of the feature tuples used to generate the defined interaction level anomaly score for the non-constant defined interaction level. For example, with respect to a first-level defined interaction level that is associated with feature tuples havingp = 1, the feature tuples of the first-level defined interaction level include singletons of feature values each comprising a single input feature value. As another example, with respect to a second-level defined interaction level that is associated with feature tuples havingp = 2, the feature tuples of the second-level defined interaction include pairs of feature values. As yet another example, with respect to a second-level defined interaction level that is associated with feature tuples havingp = 3, the feature tuples of the second-level defined interaction include triplets of feature values. In some embodiments, the non-constant defined interaction level anomaly score for a non-constant defined interaction level is determined based at least in part on each weighted feature tuple anomaly score for a feature tuple that is associated with the non-constant defined interaction level, e.g., by combining each weighted feature tuple anomaly score for a feature tuple of the feature tuples that are associated with the constant defined interaction level using a summation operation to generate the non-constant defined interaction level anomaly score for the particular non-constant defined interaction level.

The term “constant defined interaction level” may refer to a data entity that is configured to describe a defined interaction level that is configured to generate a defined interaction level anomaly score without regard to feature tuples for a predictive entity. In some embodiments, the defined interaction level anomaly score for a constant defined interaction level is determined based at least in part on a constant value, e.g., based at least in part on an anomaly distribution measure for an anomaly quantization metric across a plurality of inferred predictive entities, where the plurality of inferred predictive entities may be determined based at least in part on the one or more input feature values. In some embodiments, the constant defined interaction levels comprise a zeroth-level defined interaction level.

The term “feature tuple anomaly score” may refer to data entity that is configured to describe an observed anomalous behavior measure associated with a corresponding feature tuple. In some embodiments, determining the feature tuple anomaly score for a particular feature tuple comprises determining a partial derivative measure of an anomaly distribution measure with respect to the particular feature tuple, and determining the feature tuple anomaly score based at least in part on the partial derivative measure. In some embodiments, feature tuple anomaly score for a feature tuple pqrst is determined using the W_{pqrst}(a_{pqrst[all} _{pqrst]}, ... ) ∗ (x_{p=pqrst[all} _{pqrst]} - a_{p=pqrst[all} _{pqrst]} )term of Equation 1.

The term “feature tuple weight” may refer to a data entity that is configured to describe each per-feature weight for a feature value in a feature tuple. Accordingly, given a feature tuple having n feature values, the feature tuple weight for the feature tuple has n per-feature weights corresponding to the n feature values of the feature tuple. For example, given a first-level feature tuple having one feature value, the feature tuple weight for the feature tuple has one per-feature weight corresponding to the one feature value of the feature tuple. As another example, given a second-level feature tuple having two feature values, the feature tuple weight for the feature tuple has two per-feature weights corresponding to the two feature values of the feature tuple. As yet another example, given a third-level feature tuple having three feature values, the feature tuple weight for the feature tuple has three per-feature weights corresponding to the three feature values of the feature tuple. In some embodiments, the feature tuple weight for a feature tuple that describes an estimated contribution of the feature tuple to a predicted anomaly score that is determined based at least in part on the feature tuple. In some embodiments, feature tuple weight for a feature tuple pqrst is determined using the W_{pqrst}term of Equation 1.

The term “weighted feature tuple anomaly score” may refer to a data entity that is configured to describe the contribution of a corresponding feature tuple to a defined interaction level anomaly score for a defined interaction level that is associated with the corresponding feature tuple. The feature tuple anomaly score for a particular feature tuple that is associated with n feature values may be determined using the following operations: (i) for each feature value of the n feature values: (a) determining a per-feature weight based at least in part on the feature tuple weight for the particular feature tuple, and (b) determining a per-feature weight deviation measure for the feature value based at least in part on the feature value and the per-feature weight for the feature value; (ii) determining the weighted feature tuple anomaly score based at least in part on the feature tuple anomaly score for the particular feature tuple and each per-feature weighted feature tuple anomaly score. In some embodiments, the weight feature tuple anomaly score for a feature tuple pqrst is determined using the W_{pqrst}(a_{pqrst[all} _{pqrst]}, ... ) ∗ (x_{p=pqrst[all} _{pqrst]} - a_{p=pqrst[all} _{pqrst]}) of Equation 1.

The term “defined interaction level anomaly score” may refer to a data entity that is configured to describe the output of a defined interaction level that contributes to a predicted anomaly score. In some embodiments, when the defined interaction level is a constant defined interaction level, the defined interaction level anomaly score for the constant defined interaction level is determined based at least in part on an anomaly distribution measure for an anomaly quantization metric across a plurality of inferred predictive entities, where a plurality of inferred predictive entities may be determined based at least in part on the one or more input feature values. In some embodiments, when the defined interaction level is a non-constant defined interaction level, the defined interaction level anomaly score for the non-constant defined interaction level is determined by combining each weighted feature tuple anomaly score for a feature tuple of the n feature value combinations that are associated with the non-constant defined interaction level using a summation operation to generate the non-constant defined interaction level anomaly score for the particular non-constant defined interaction level.

The term “predicted anomaly score” may refer to a data entity that is configured to describe an estimated score that describes the likelihood that a predictive entity is engaging in anomalous activity, such as in fraudulent activity. For example, the predicted anomaly score for a predictive entity that is associated with a healthcare provider may describe the likelihood that the healthcare provider is engaging in fraudulent activities. As another example, the predicted anomaly score for a predictive entity that is associated with a health insurance member may describe the likelihood that the health insurance member is engaging in fraudulent activities. In some embodiments, the predicted anomaly score for a predictive entity describes the likelihood that composite predictive entities generated based at least in part on feature values extracted from two or more datasets/databases/tables. This way, the predicted anomaly score may describe the likelihood that a super-entity that is generated based at least in part on feature values extracted from two or more datasets/databases/tables is engaging in anomalous activity.

The term “anomaly distribution measure” may refer to a data entity that is configured to describe a measure of distribution of anomaly scores over a set of inferred predictive entities. For example, the anomaly distribution measure may describe an anomaly quantization metric over a set of inferred predictive data entities. Examples of anomaly quantization metrics describe a statistical distribution measure for the likelihood that an entity is associated with fraud, waste, and abuse (FWA), a statistical distribution measure of a most likely amount of loss paid in relation to an entity due to FWA, a statistical distribution measure for a most likely lost amount from an entity due to FWA, a statistical distribution of FWA likelihood by an entity, a statistical distribution of amount of money diversion by an entity due to FWA, and/or the like. Examples of statistical distribution measures include mean measures, total amount measures, median measures, second moment of mean measures, third moment of mean measures, and/or the like. In some embodiments, statistical distribution measures are determined based at least in part on centroid values, such as centroid values that are determined using one or more determined ensemble statistic measures.

The term “inferred predictive entity” may refer to a data entity that is configured to describe a data field characterized by a unique combination of feature types described by a selected key feature combination. In some embodiments, the unique combination comprises the feature types of the feature values. In some embodiments, the selected key feature combination is determined by enumerating a set of identifiers at their most granular level (e.g., State-Zip5-Sex-Birth Date-Last Name-First Name-Plan). In some embodiments, inferred predictive entities are determined based at least in part on synthetic-composite keys for entities.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises a combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

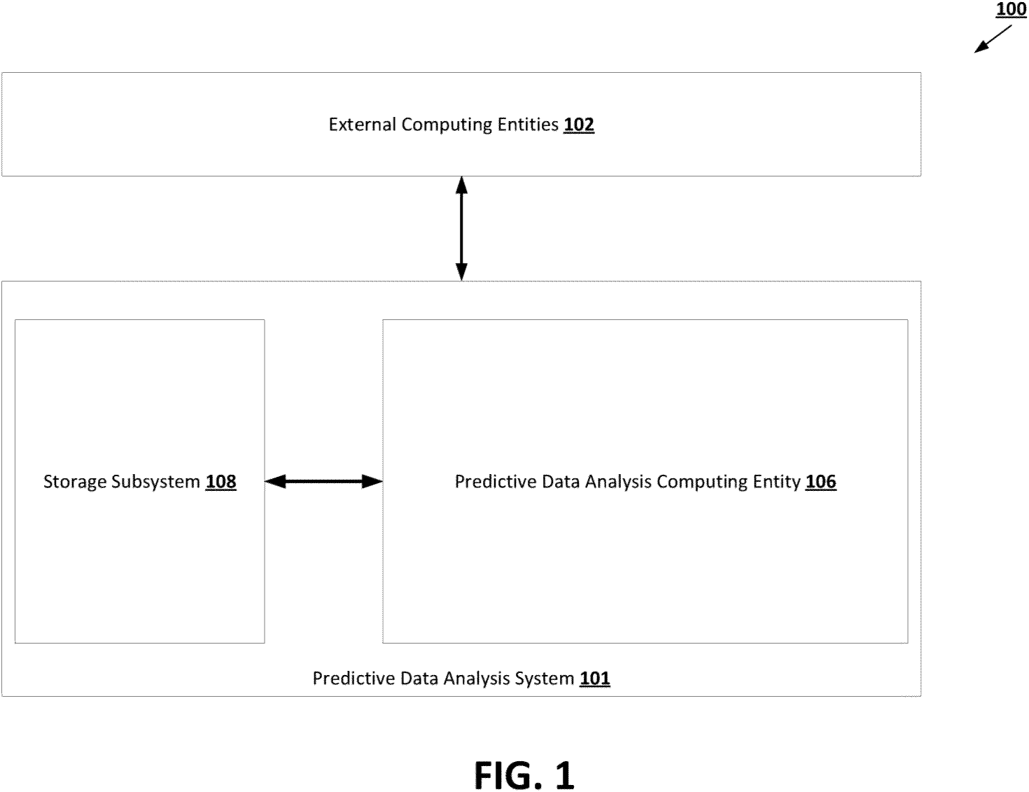

FIG. 1 is a schematic diagram of an example architecture 100 for performing predictive data analysis. The architecture 100 includes a predictive data analysis system 101 configured to receive predictive data analysis requests from external computing entities 102, process the predictive data analysis requests to generate predictions, provide the generated predictions to the external computing entities 102, and automatically perform prediction-based actions based at least in part on the generated predictions. Examples of predictive tasks that can be performing using the predictive data analysis system 101 include a predictive anomaly detection task, such as a predictive fraud detection task.

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more external computing entities 102, process the predictive data analysis requests to generate predictions corresponding to the predictive data analysis requests, provide the generated predictions to the external computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

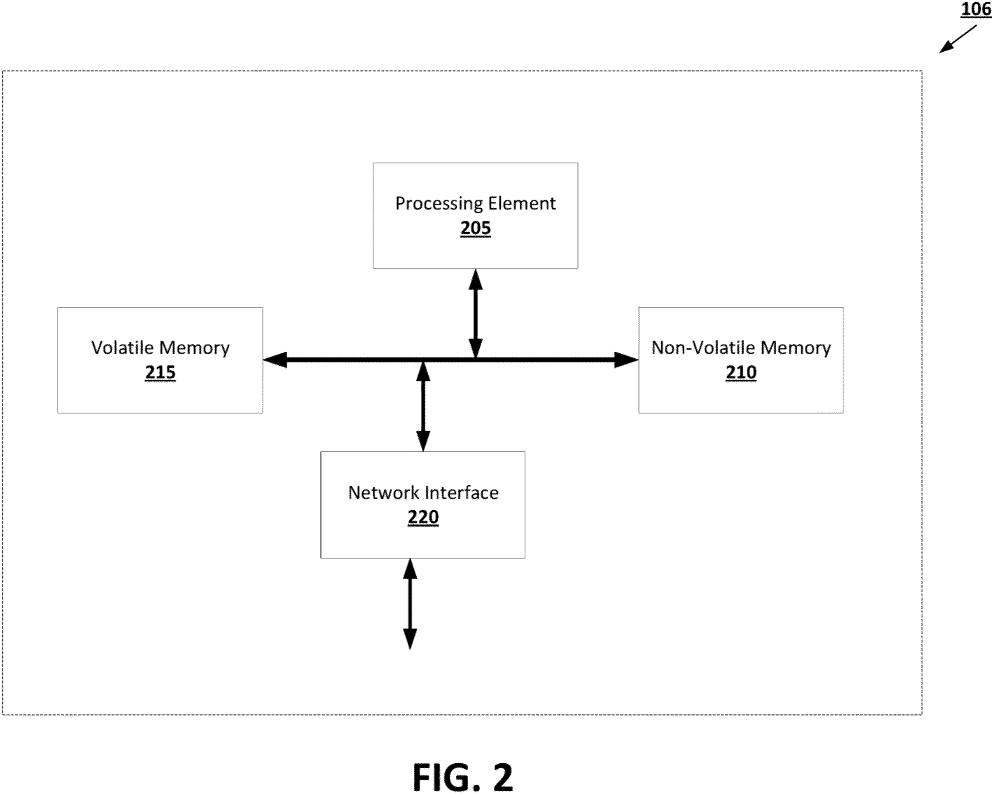

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entityrelationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary External Computing Entity

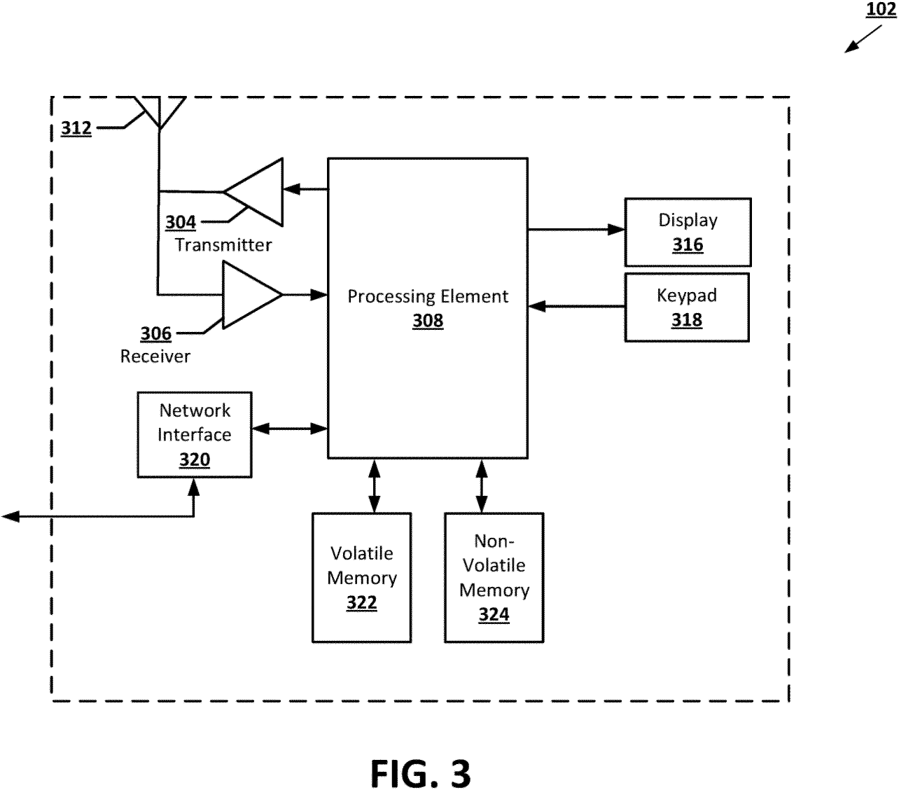

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity’s 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

As described below, various embodiments of the present invention introduce techniques for predictive anomaly detection that are able to efficiently and reliably generate predictive inferences across datasets/databases/tables in order to detect patterns of fraudulent activities that may be harder to detect using a single dataset/database/table. In doing so, various embodiments of the present invention enable cross-dataset/database/table inferences that do not require complex operations for cross-dataset/database/table correlations in order to generate training data for a predictive anomaly detection solution that is able to perform cross-dataset/database/table predictive anomaly detection inferences. In this way, various embodiments of the present invention address the efficiency and reliability shortcomings of existing predictive anomaly detection solutions.

For example, various embodiments of the present invention utilize systems, methods, and computer program products that perform predictive anomaly detection by utilizing at least one of defined interaction level anomaly scores, such as defined interaction level anomaly scores for non-constant defined interaction levels that are determined using weighted feature tuple anomaly scores for feature tuple values that are associated with the non-constant defined interaction levels, as well as defined interaction level anomaly scores for constant defined interaction levels that are determined using an anomaly distribution measure for an anomaly quantization metric across a plurality of inferred predictive entities. In doing so, various embodiments of the present invention enable cross-dataset/database/table inferences that do not require complex operations for cross-dataset/database/table correlations in order to generate training data for a predictive anomaly detection solution that is able to perform cross-dataset/database/table predictive anomaly detection inferences.

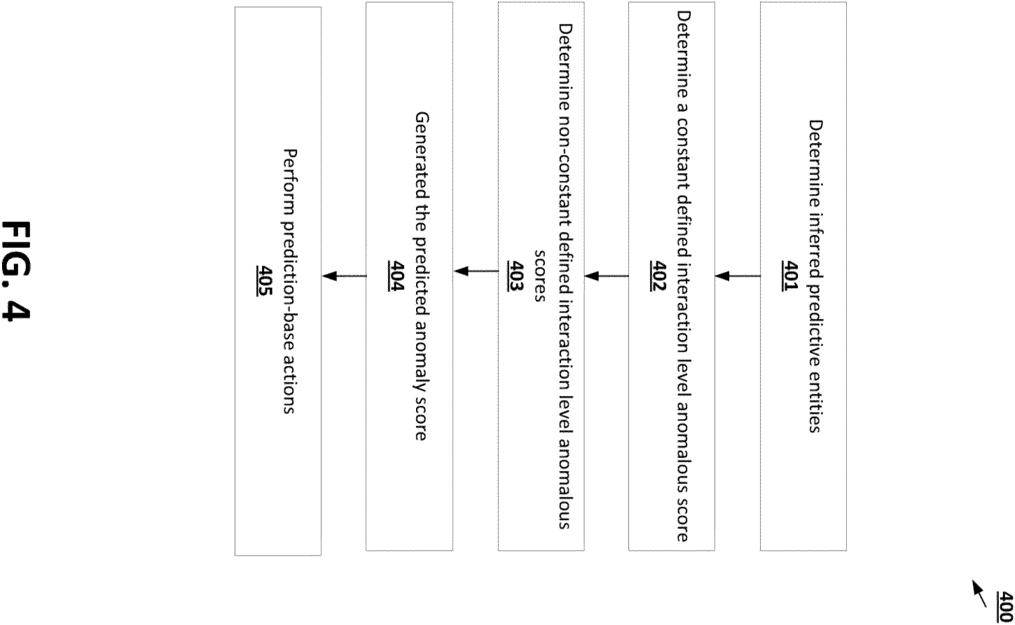

FIG. 4 is a flowchart diagram of an example process 400 for determining a predicted anomaly score for a predictive entity. Via the various steps/operations of the process 400, the predictive data analysis computing entity 106 can determine a predicted anomalous score that describes the likelihood that a super-entity that is generated based at least in part on feature values extracted from two or more datasets/databases/tables is engaging in anomalous activity.

The process 400 begins at step/operation 401 when the predictive data analysis computing entity 106 determines a set of inferred predictive entities based at least in part on a set of datasets/databases/tables. Each inferred predictive entity may be a data field characterized by a unique combination of feature types described by a selected key feature combination. In some embodiments, the unique combination comprises the feature types of the feature values. In some embodiments, the selected key feature combination is determined by enumerating a set of identifiers at their most granular level (e.g.: State-Zip5-Sex-Birth Date-Last Name-First Name-Plan). In some embodiments, inferred predictive entities are determined based at least in part on synthetic-composite keys for entities. In some embodiments, the predictive data analysis computing entity 106 extracts relationships across inferred predictive data entities from one or more source datasets/databases/tables.

At step/operation 402, the predictive data analysis computing entity 106 optionally determines a constant defined interaction level anomaly score for a zeroth constant defined interaction level for the predictive entity. In some embodiments, a constant defined interaction level is a defined interaction level that is configured to generate a defined interaction level anomaly score without regard to feature tuples for a predictive entity. In some embodiments, the defined interaction level anomaly score for a constant defined interaction level is determined based at least in part on a constant value, e.g., based at least in part on an anomaly distribution measure for an anomaly quantization metric across a plurality of inferred predictive entities, where the plurality of inferred predictive entities may be determined based at least in part on one or more input feature values. In some embodiments, the constant defined interaction levels comprise a zeroth-level defined interaction level. In some embodiments, during an optimization process, the constant defined interaction level anomaly score may be deleted after determining that the effect of the constant defined interaction level anomaly score on generated predicted anomaly scores fails to satisfy a significance threshold.

At step/operation 403, the predictive data analysis computing entity 106 determines non-constant defined interaction level anomaly scores for a defined set of non-constant defined interaction levels. For example, the predictive data analysis computing entity 106 may determine a first-level non-constant defined interaction level anomaly score for a first-level non-constant defined interaction level. As another example, the predictive data analysis computing entity 106 may determine a first-level non-constant defined interaction level anomaly score for a first-level non-constant defined interaction level and a second-level non-constant defined interaction level anomaly score for a second-level non-constant defined interaction level. As yet another example, the predictive data analysis computing entity 106 may determine a first-level non-constant defined interaction level anomaly score for a first-level non-constant defined interaction level, a second-level non-constant defined interaction level anomaly score for a second-level non-constant defined interaction level, and a third-level non-constant defined interaction level anomaly score for a third-level non-constant defined interaction level.

A defined interaction level may describe a set of operations that are performed to generate a defined interaction level anomaly score that in turn can be used to generate a predicted anomaly score for a predictive entity. In some embodiments, generating a predicted anomaly score for a predictive entity comprises performing operations corresponding to a set of defined interaction levels, where each defined interaction level is associated with a level number, and where the level number for each non-constant defined interaction level describes a feature value count for (i.e., the number of feature values in feature tuples that are associated with) the non-constant defined interaction level. For example, in some embodiments, the non-constant defined interaction levels comprise a first-level defined interaction level that performs operations on the singletons of feature values in order to generate a first-level defined interaction level anomaly score. As another example, in some embodiments, the non-constant defined interaction levels comprise a second-level defined interaction level that performs operations on the pairs of feature values in order to generate a second-level defined interaction level anomaly score. As another example, in some embodiments, the non-constant defined interaction levels comprise a third-level defined interaction level that performs operations on the triplets of feature values in order to generate a third-level defined interaction level anomaly score. In some embodiments, the constant defined interaction levels comprise a zeroth-level defined interaction level whose defined interaction level anomaly score is determined based at least in part on an anomaly distribution measure for an anomaly quantization metric across a plurality of inferred predictive entities, wherein the plurality of inferred predictive entities are determined based at least in part on the one or more defined input feature values.

In some embodiments, a non-constant defined interaction level describes a defined interaction level that is configured to generate a defined interaction level anomaly score based at least in part on feature tuples for a predictive entity. As described above, the level number of a non-constant defined interaction level may define the size of the feature tuples used to generate the defined interaction level anomaly score for the non-constant defined interaction level. For example, with respect to a first-level defined interaction level that is associated with feature tuples havingp = 1, the feature tuples of the first-level defined interaction level include singletons of feature values each comprising a single input feature value. As another example, with respect to a second-level defined interaction level that is associated with feature tuples having p = 2, the feature tuples of the second-level defined interaction include pairs of feature values. As yet another example, with respect to a second-level defined interaction level that is associated with feature tuples havingp = 3, the feature tuples of the second-level defined interaction include triplets of feature values. In some embodiments, the non-constant defined interaction level anomaly score for a non-constant defined interaction level is determined based at least in part on each weighted feature tuple anomaly score for a feature tuple that is associated with the non-constant defined interaction level, e.g., by combining each weighted feature tuple anomaly score for a feature tuple of the feature tuples that are associated with the constant defined interaction level using a summation operation to generate the non-constant defined interaction level anomaly score for the particular non-constant defined interaction level.

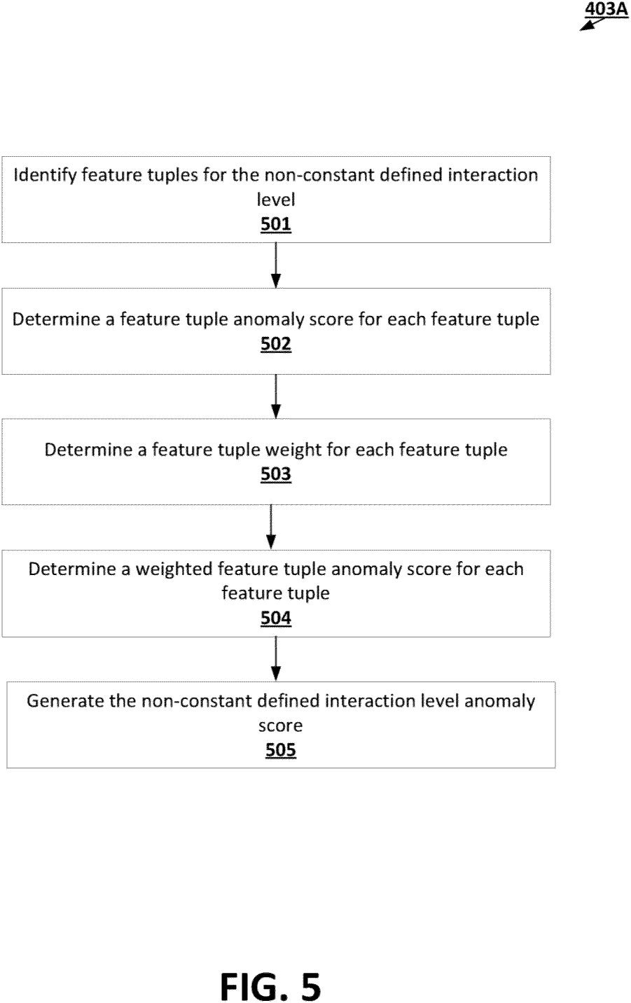

In some embodiments, step/operation 403 may be performed by performing the process 403A that is depicted in FIG. 5 for a non-constant defined interaction level having a particular order number. The process 403A describes an example process for determining a defined interaction level anomaly score for a particular non-constant defined interaction level. The process 403A begins at step/operation 501 when the predictive data analysis computing entity 106 identifies the feature tuples for each the particular non-constant defined interaction level.

A feature tuple may be a combination of n feature values of a predictive entity, where at least one of the n feature values is selected from the input feature values for the predictive entity, and where the precise value ofp for a feature tuple defines the defined interaction level that is associated with the feature tuple. For example, with respect to a first-level defined interaction level that is associated with feature tuples havingp = 1, the feature tuples of the first-level defined interaction level include singletons of feature values each comprising a single input feature value. As another example, with respect to a second-level defined interaction level that is associated with feature tuples havingp = 2, the feature tuples of the second-level defined interaction include pairs of feature values. As yet another example, with respect to a second-level defined interaction level that is associated with feature tuples havingp = 3, the feature tuples of the second-level defined interaction include triplets of feature values.

At step/operation 502, the predictive data analysis computing entity 106 determines a feature tuple anomaly score for each feature tuple that is associated with the particular non-constant defined interaction level. A feature tuple anomaly score describes an observed anomalous behavior measure associated with a corresponding feature tuple. In some embodiments, determining the feature tuple anomaly score for a particular feature tuple comprises determining a partial derivative measure of an anomaly distribution measure with respect to the particular feature tuple, and determining the feature tuple anomaly score based at least in part on the partial derivative measure.

At step/operation 503, the predictive data analysis computing entity 106 determines a feature tuple weight for each feature tuple that is associated with the particular non-constant defined interaction level. A feature tuple weight may describe each per-feature weight for a feature value in a feature tuple. Accordingly, given a feature tuple having n feature values, the feature tuple weight for the feature tuple has n per-feature weights corresponding to the n feature values of the feature tuple. For example, given a first-level feature tuple having one feature value, the feature tuple weight for the feature tuple has one per-feature weight corresponding to the one feature value of the feature tuple. As another example, given a second-level feature tuple having two feature values, the feature tuple weight for the feature tuple has two per-feature weights corresponding to the two feature values of the feature tuple. As yet another example, given a third-level feature tuple having three feature values, the feature tuple weight for the feature tuple has three per-feature weights corresponding to the three feature values of the feature tuple. In some embodiments, the feature tuple weight for a feature tuple that describes an estimated contribution of the feature tuple to a predicted anomaly score that is determined based at least in part on the feature tuple.

At step/operation 504, the predictive data analysis computing entity 106 determines the weighted feature tuple anomaly score for each feature tuple that is associated with the particular non-constant defined interaction level based at least in part on the feature tuple anomaly score for the feature tuple and the feature tuple weight for the feature tuple. In some embodiments, the feature tuple anomaly score describes the contribution of a corresponding feature tuple to a defined interaction level anomaly score for a defined interaction level that is associated with the corresponding feature tuple. The feature tuple anomaly score for a particular feature tuple that is associated with n feature values may be determined using the following operations: (i) for each feature value of the n feature values: (a) determining a per-feature weight based at least in part on the feature tuple weight for the particular feature tuple, and (b) determining a per-feature weight deviation measure for the feature value based at least in part on the feature value and the per-feature weight for the feature value; (ii) determining the weighted feature tuple anomaly score based at least in part on the feature tuple anomaly score for the particular feature tuple and each per-feature weighted feature tuple anomaly score.

At step/operation 505, the predictive data analysis computing entity 106 determines the defined interaction level anomaly score based at least in part on each weighted feature tuple anomaly score for a feature tuple that is associated with the non-constant defined interaction level. In some embodiments, a weighted feature tuple anomaly score describes the output of a defined interaction level that contributes to a predicted anomaly score. In some embodiments, when the defined interaction level is a constant defined interaction level, the defined interaction level anomaly score for the constant defined interaction level is determined based at least in part on an anomaly distribution measure for an anomaly quantization metric across a plurality of inferred predictive entities, where the plurality of inferred predictive entities may be determined based at least in part on the one or more input feature values.

In some embodiments, when the defined interaction level is a non-constant defined interaction level, the defined interaction level anomaly score for the non-constant defined interaction level is determined by combining each weighted feature tuple anomaly score for a feature tuple of the n feature tuples that are associated with the non-constant defined interaction level using a summation operation to generate the non-constant defined interaction level anomaly score for the particular non-constant defined interaction level.

In some embodiments, the non-constant defined interaction level anomaly score for a particular feature tuple that is associated with a first-level non-constant defined interaction level is determined based at least in part on variations of the anomaly quantization metric across a plurality of inferred predictive entities. In some embodiments, the non-constant defined interaction level anomaly score for a particular feature tuple that is associated with a second-level non-constant defined interaction level is determined based at least in part on variations of the anomaly quantization metric across predictive entity pairs selected from a plurality of inferred predictive entities. In some embodiments, the non-constant defined interaction level anomaly score for a particular feature tuple that is associated with a third-level non-constant defined interaction level is determined based at least in part on variations of the anomaly quantization metric across predictive entity triplets selected from a plurality of inferred predictive entities.

Accordingly, as described in step/operation 403 and/or in the process 403A, various embodiments of the present invention utilize systems, methods, and computer program products that perform predictive anomaly detection by utilizing at least one of defined interaction level anomaly scores, such as defined interaction level anomaly scores for non-constant defined interaction levels that are determined using weighted feature tuple anomaly scores for feature tuple values that are associated with the non-constant defined interaction levels, as well as defined interaction level anomaly scores for constant defined interaction levels that are determined using an anomaly distribution measure for an anomaly quantization metric across a plurality of inferred predictive entities. In doing so, various embodiments of the present invention enable cross-dataset/database/table inferences that do not require complex operations for cross-dataset/database/table correlations in order to generate training data for a predictive anomaly detection solution that is able to perform cross-dataset/database/table predictive anomaly detection inferences.

At step/operation 404, the predictive data analysis computing entity 106 generates the predicted anomaly score based at least in part on the constant defined interaction level anomaly score and each non-constant defined interaction level anomaly score. In some embodiments, the predicted anomaly score describes an estimated score that describes the likelihood that a predictive entity is engaging in anomalous activity, such as in fraudulent activity. For example, the predicted anomaly score for a predictive entity that is associated with a healthcare provider may describe the likelihood that the healthcare provider is engaging in fraudulent activities. As another example, the predicted anomaly score for a predictive entity that is associated with a health insurance member may describe the likelihood that the health insurance member is engaging in fraudulent activities. In some embodiments, the predicted anomaly score for a predictive entity describes the likelihood that composite predictive entities generated based at least in part on feature values extracted from two or more datasets/databases/tables. This way, the predicted anomaly score may describe the likelihood that a super-entity that is generated based at least in part on feature values extracted from two or more datasets/databases/tables is engaging in anomalous activity.

In some embodiments, the predicted anomaly score is determined based on the output of the below equation:

$$\begin{matrix}≅ {\sum }_{a l l p} {\sum }_{a l l q} {\sum }_{a l l r} {\sum }_{a l l s} {\sum }_{a l l \text{} t} \begin{matrix}\text{T} \left({x}_{p q r s t \left[a l l p q r s t\right]}\right) \\ {W}_{p q r s t} \left({a}_{p q r s t \left[a l l p q r s t\right]} , …\right)\end{matrix} \\ ∗ \left({x}_{p = p q r s t \left[a l l p q r s t\right]} - {a}_{p = p q r s t \left[a l l p q r s t\right]}\right)\end{matrix}$$

In Equation 1, p iterates over defined interaction levels, q iterates over first-level features (e.g., ensembles, such as an ensemble corresponding to a provider entity, an ensemble corresponding to a member entity, an ensemble corresponding to a procedure entity, and/or the like), r iterates over second-level features (e.g., elements of ensembles, such as a TIN element or an NPI element for a provider entity ensemble, an SSN element or a SZSBLF (State - Zip - Sex -Birth Date - Last Name - First Name) element for a provider entity ensemble, and/or the like), s iterates over third-level features (e.g., enumeration of ensemble elements, such as TIN1 and TIN2 for a TIN ensemble element, NPI1 or NPI2 for an NPI ensemble element, and/or the like), and t iterates over anomaly quantization measures (e.g., an amount paid anomaly quantization measure, a claim count anomaly quantization measure, an anomaly quantization measure describing a deviation of a metric associated with the feature tuple from an average, and/or the like).

In Equation 1, the defined interaction level that is determined by p defines the number of feature values characterizing a first-level feature. For example, for p = 1, examples of first-level features include an ensemble corresponding to a provider entity, an ensemble corresponding to a member entity, an ensemble corresponding to a procedure entity, and/or the like. As another example, for p = 2, examples of first-level features include an ensemble corresponding to a combination of two provider entities, a combination of a provider entity and a member entity, and/or the like. As yet another example, for p = 3, examples of first-level features include an ensemble corresponding to a combination of two provider entities and a procedure entity; a combination of a provider entity, a procedure entity, and a member entity, and/or the like.

Furthermore, in Equation 1, each nth level feature is associated with a set of (n+1)th level features in a hierarchical manner, such that an nth level feature defines the range of potential (n+1)th level features in a single feature tuple. For example, if q = member, then r may be selected from a set of potential member designators including member ID, member SSN, member SZBLF, and/or the like. As another example, if r = SSN, then s may be selected from a set of potential SSN enumerations such as SSN1, SSN2, and/or the like.

In some embodiments, a feature tuple described by a combination of p, q, r, s, and t describes an anomaly quantization measure for an inferred entity defined by p, q, r, and s. An example feature tuple may describe the amount paid by a member having a particular SSN1 to a provider having a particular TIN1. Another example of a feature tuple may be the count of claims by a member having a particular SZBLF2 for a claim having a particular CPT3.

In some embodiments, in Equation 1, W_{pqrst} is an assigned weight to a data tuple associated with a feature tuple defined by p, q, r, s, and t. In some embodiments, the assigned weight is set to one if qrs matches a target combination of nth level features, and is set to zero otherwise. For example, if p=1 qrs refers to a TIN1=“123456,” then all tuples having the noted TIN1 are assigned a weight of one, and all other tuples are assigned a weight of zero. As another example, if p=2 qrs refers to a combination of SSN1 = “674445511” and TIN1=“123456,” then all tuples having the noted SSN1-TIN1 are assigned a weight of one, and all other tuples are assigned a weight of zero. In some embodiments, W_{pqrst} for a data tuple is assigned a value [0, 1] even if qrs fails to match a target combination of nth level features. For example, in some embodiments, a trained regression-based machine learning model is used to determine a measure of association between the qrs and the target combination, and the assigned weight is determined based on the determined measure of association. For example, if p=2 qrs refers to a NPI1=“456789” and TIN1=” 123456,” and if the described provider is associated with hospital H₁ (TIN1), then the regression-based machine learning model may use hospital associations to determine a recommended weight for those data tuples to providers in H₁.

Moreover, in Equation 1, x_{p=pqrst[all} _{pqrst]} describes the anomaly quantization measure for an inferred predictive entity defined by pqrst (e.g., the amount paid by a particular combination of a TIN1 and an SSN2), while a_{p=pqrst[all} _{pqrst]} describes a centroid measure and/or other anomaly distribution measure for the anomaly quantization measure across all of the inferred predictive entities. In some embodiments, if t is not a deviation from average measure, then a_{p=pqrst[all} _{pqrst]} may be zero, and if t is a deviation from average measure, then a_{p=pqrst[all} _{pqrst]} may be a centroid measure such as an average measure.

Equation 1 describes a general form that can be used to infer any non-constant defined interaction levels that are permitted by a defined range for p. For example, for p = 1, the following defined interaction level may be determined:

$$\begin{matrix}+ {\sum }_{j = 1}^{d} {W}_{1} \left({a}_{1} , … , {a}_{d}\right) ∗ \left({x}_{j} - {a}_{j}\right) \\ \begin{matrix}= + {\sum }_{p = 1} {\sum }_{a l l q} {\sum }_{a l l r} {\sum }_{a l l s} {\sum }_{a l l t} {W}_{p = 1 q r s t} \left({a}_{p = 1 q r s t \left[a l l q r s t\right]} , …\right) ∗ \\ \left({x}_{p = 1 q r s t \left[a l l q r s t\right]} - {a}_{p = 1 q r s t \left[a l l q r s t\right]}\right)\end{matrix}\end{matrix}$$

As another example, for p = 2, the following defined interaction level may be determined:

$$\begin{matrix}+ {\sum }_{j = 1}^{d} {\sum }_{k = 1}^{d} {W}_{2} \left({a}_{1} , … , {a}_{d}\right) ∗ \left({x}_{j} - {a}_{j}\right) ∗ \left({x}_{k} - {a}_{k}\right) = \\ + {\sum }_{p = 2} {\sum }_{a l l q} {\sum }_{a l l r} {\sum }_{a l l s} {\sum }_{a l l t} {W}_{p = 2 q r s t} \left({a}_{p = 2 q r s t \left[a l l q r s t\right]} , …\right) ∗ \left({x}_{p = 2 q r s t \left[a l l q r s t\right]} - {a}_{p = 2 q r s t \left[a l l q r s t\right]}\right)\end{matrix}$$

As yet another example, for p = 3, the following defined interaction level may be determined:

$$\begin{matrix}+ {\sum }_{j = 1}^{d} {\sum }_{k = 1}^{d} {\sum }_{l = 1}^{d} {W}_{3} \left({a}_{1} , … , {a}_{d}\right) ∗ \left({x}_{j} - {a}_{j}\right) ∗ \left({x}_{k} - {a}_{k}\right) ∗ \left({x}_{l} - {a}_{l}\right) = \\ + {\sum }_{p = 3} {\sum }_{a l l q} {\sum }_{a l l r} {\sum }_{a l l s} {\sum }_{a l l t} {W}_{p = 3 q r s t} \left({a}_{p = 3 q r s t \left[a l l q r s t\right]} , …\right) ∗ \\ \left({x}_{p = 3 q r s t \left[a l l q r s t\right]} - {a}_{p = 3 q r s t \left[a l l q r s t\right]}\right)\end{matrix}$$

In some embodiments, at least one of the following terms of the Taylor series of Equation 1 may be generated via optimization during training: (i) the partial derivative terms, (ii) anomaly distribution measures, and (iii) per-feature weight values. In some embodiments, the noted optimization is performed based at least in part ground-truth predictive anomaly scores, such as ground-truth statistical distribution measures for the likelihoods that entities are associated with fraud, waste, and abuse (FWA), ground-truth statistical distribution measures of most likely amounts of loss paid in relation to entities due to FWA, ground-truth statistical distribution measures for most likely lost amount from entities due to FWA, ground-truth statistical distribution measures of FWA likelihood by entities, ground-truth statistical distribution measures of amount of money diversion by entities due to FWA, and/or the like. Examples of statistical distribution measures include mean measures, total amount measures, median measures, second moment of mean measures, third moment of mean measures, and/or the like. In some embodiments, statistical distribution measures are determined based at least in part on centroid values, such as centroid values that are determined using one or more determined ensemble statistic measures.

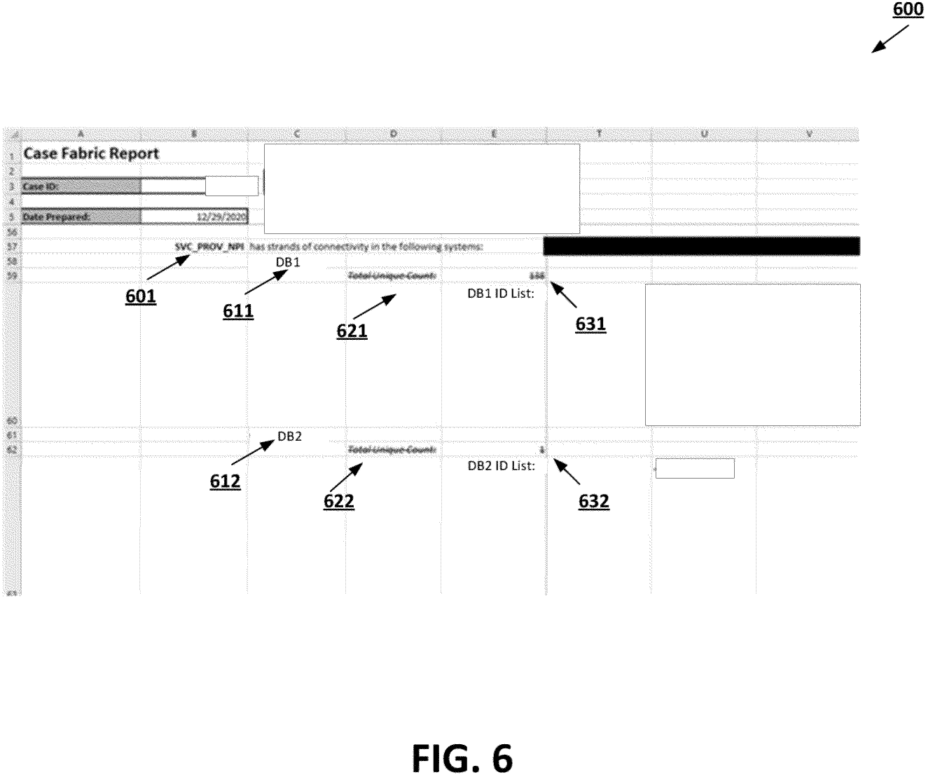

At step/operation 405, the predictive data analysis computing entity 106 performs one or more prediction-based actions based at least in part on the predicted anomaly score. Examples of prediction-based actions include generating automated alerts based at least in part on the predicted anomaly score, generating one or more automated anomaly processing tasks based at least in part on the predicted anomaly score, and/or the like. In some embodiments, performing the prediction-based actions comprises generating user interface data for a prediction output use interface that displays data related to the predicted anomaly score. An operational example of such a prediction output user interface 600 is depicted in FIG. 6. As depicted in FIG. 6, the prediction output user interface 600 describes strands of activity for a predictive entity whose predicted anomaly score satisfies a predicted anomaly score threshold. For example, the prediction output user interface 600 describes that the feature tuple associated with p = 1, the ensemble and the ensemble element 601, the ensemble enumeration source 611, and the anomaly quantization measure 621 is associated with the weighted feature tuple anomaly score 631. As another example, the prediction output user interface 600 describes that the feature tuple associated with p = 1, the ensemble and the ensemble element 601, the ensemble enumeration source 612, and the anomaly quantization measure 622 is associated with the weighted feature tuple anomaly score 632.

As described above, various embodiments of the present invention introduce techniques for predictive anomaly detection that are able to efficiently and reliably generate predictive inferences across datasets/databases/tables in order to detect patterns of fraudulent activities that may be harder to detect using a single dataset/database/table. In doing so, various embodiments of the present invention enable cross-dataset/database/table inferences that do not require complex operations for cross-dataset/database/table correlations in order to generate training data for a predictive anomaly detection solution that is able to perform cross-dataset/database/table predictive anomaly detection inferences. In this way, various embodiments of the present invention address the efficiency and reliability shortcomings of existing predictive anomaly detection solutions.

### VI Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a predicted anomaly score for a predictive entity, the computer-implemented method comprising:
identifying, using a processor, a plurality of feature tuples, wherein: (i) each feature tuple is associated with a defined interaction level of one or more non-constant defined interaction levels, and (ii) each feature value count for a feature tuple is determined based at least in part on the non-constant defined interaction level that is associated with the feature tuple;
for each feature tuple:
determining, using the processor, a feature tuple anomaly score that describes an observed anomalous behavior measure associated with the feature tuple,
identifying, using the processor, a feature tuple weight for the feature tuple that describes an estimated contribution of the feature tuple to the predicted anomaly score, and
determining, using the processor, a weighted feature tuple anomaly score for the feature tuple based at least in part on the feature tuple anomaly score and the feature tuple weight;
for each non-constant defined interaction level, determining, using the processor, a non-constant defined interaction level anomaly score based at least in part on each weighted feature tuple anomaly score that is associated with the non-constant defined interaction level;
generating, using the processor, the predicted anomaly score based at least in part on each non-constant defined interaction level anomaly score; and
performing, using the processor, one or more prediction-based actions based at least in part on the predicted anomaly score.

2. The computer-implemented method of claim 1, wherein determining the feature tuple anomaly score for a particular feature tuple comprises:
determining a partial derivative measure of an anomaly distribution measure with respect to the particular feature tuple, and
determining the feature tuple anomaly score based at least in part on the partial derivative measure.

3. The computer-implemented method of claim 1, wherein determining the non-constant defined interaction level anomaly score for a particular non-constant defined interaction level that is associated with a defined number of feature tuples comprises:
combining each weighted feature tuple anomaly score for a feature tuple of the defined number of feature tuples using a summation operation to generate the non-constant defined interaction level anomaly score for the particular non-constant defined interaction level.

4. The computer-implemented method of claim 1, wherein determining the weighted feature tuple anomaly score for a particular feature tuple that is associated with a defined number of feature values comprises:
for each feature value of the defined number of feature values:
determining a per-feature weight based at least in part on the feature tuple weight for the particular feature tuple, and
determining a per-feature weight deviation measure for the feature value based at least in part on the feature value and the per-feature weight for the feature value; and
determining the weighted feature tuple anomaly score based at least in part on the feature tuple anomaly score for the particular feature tuple and each per-feature weighted feature tuple anomaly score.

5. The computer-implemented method of claim 1, wherein:
for a pth-level non-constant defined interaction level, each feature value combination comprisesp feature tuples.

6. The computer-implemented method of claim 5, wherein each feature tuple is associated with an ensemble, an ensemble element, and an ensemble element enumeration.

7. The computer-implemented method of claim 5, wherein each feature tuple is associated with an assigned weight value that is determined based on an output of processing one or more features of the feature tuple using a trained regression-based machine learning model.

8. An apparatus for generating a predicted anomaly score for a predictive entity, the apparatus comprising at least one processor and at least one memory including program code, the at least one memory and the program code configured to, with the processor, cause the apparatus to at least:
identify a plurality of feature tuples, wherein: (i) each feature tuple is associated with a defined interaction level of one or more non-constant defined interaction levels, and (ii) each feature value count for a feature tuple is determined based at least in part on the non-constant defined interaction level that is associated with the feature tuple;
for each feature tuple:
determine a feature tuple anomaly score that describes an observed anomalous behavior measure associated with the feature tuple,
identify a feature tuple weight for the feature tuple that describes an estimated contribution of the feature tuple to the predicted anomaly score, and
determine a weighted feature tuple anomaly score for the feature tuple based at least in part on the feature tuple anomaly score and the feature tuple weight;
for each non-constant defined interaction level, determine a non-constant defined interaction level anomaly score based at least in part on each weighted feature tuple anomaly score that is associated with the non-constant defined interaction level;
generate the predicted anomaly score based at least in part on each non-constant defined interaction level anomaly score; and
perform one or more prediction-based actions based at least in part on the predicted anomaly score.

9. The apparatus of claim 8, wherein determining the feature tuple anomaly score for a particular feature tuple comprises:
determining a partial derivative measure of an anomaly distribution measure with respect to the particular feature tuple, and
determining the feature tuple anomaly score based at least in part on the partial derivative measure.

10. The apparatus of claim 8, wherein determining the non-constant defined interaction level anomaly score for a particular non-constant defined interaction level that is associated with a defined number of feature tuples comprises:
combining each weighted feature tuple anomaly score for a feature tuple of the defined number of feature tuples using a summation operation to generate the non-constant defined interaction level anomaly score for the particular non-constant defined interaction level.

11. The apparatus of claim 8, wherein determining the weighted feature tuple anomaly score for a particular feature tuple that is associated with a defined number of feature values comprises:
for each feature value of the defined number of feature values:
determining a per-feature weight based at least in part on the feature tuple weight for the particular feature tuple, and
determining a per-feature weight deviation measure for the feature value based at least in part on the feature value and the per-feature weight for the feature value; and
determining the weighted feature tuple anomaly score based at least in part on the feature tuple anomaly score for the particular feature tuple and each per-feature weighted feature tuple anomaly score.

12. The apparatus of claim 8, wherein:
for a pth-level non-constant defined interaction level, each feature value combination comprisesp feature tuples.

13. The apparatus of claim 12, wherein each feature tuple is associated with an ensemble, an ensemble element, and an ensemble element enumeration.

14. The apparatus of claim 12, wherein each feature tuple is associated with an assigned weight value that is determined based on an output of processing one or more features of the feature tuple using a trained regression-based machine learning model.

15. A computer program product for generating a predicted anomaly score for a predictive entity, the computer program product comprising at least one non-transitory computer-readable storage medium having computer-readable program code portions stored therein, the computer-readable program code portions configured to:
identify a plurality of feature tuples, wherein: (i) each feature tuple is associated with a defined interaction level of one or more non-constant defined interaction levels, and (ii) each feature value count for a feature tuple is determined based at least in part on the non-constant defined interaction level that is associated with the feature tuple;
for each feature tuple:
determine a feature tuple anomaly score that describes an observed anomalous behavior measure associated with the feature tuple,
identify a feature tuple weight for the feature tuple that describes an estimated contribution of the feature tuple to the predicted anomaly score, and
determine a weighted feature tuple anomaly score for the feature tuple based at least in part on the feature tuple anomaly score and the feature tuple weight;
for each non-constant defined interaction level, determine a non-constant defined interaction level anomaly score based at least in part on each weighted feature tuple anomaly score that is associated with the non-constant defined interaction level;
generate the predicted anomaly score based at least in part on each non-constant defined interaction level anomaly score; and
perform one or more prediction-based actions based at least in part on the predicted anomaly score.

16. The computer program product of claim 15, wherein determining the feature tuple anomaly score for a particular feature tuple comprises:
determining a partial derivative measure of an anomaly distribution measure with respect to the particular feature tuple, and
determining the feature tuple anomaly score based at least in part on the partial derivative measure.

17. The computer program product of claim 15, wherein determining the non-constant defined interaction level anomaly score for a particular non-constant defined interaction level that is associated with a defined number of feature tuples comprises:
combining each weighted feature tuple anomaly score for a feature tuple of the defined number of feature tuples using a summation operation to generate the non-constant defined interaction level anomaly score for the particular non-constant defined interaction level.

18. The computer program product of claim 15, wherein determining the weighted feature tuple anomaly score for a particular feature tuple that is associated with a defined number of feature values comprises:
for each feature value of the defined number of feature values:
determining a per-feature weight based at least in part on the feature tuple weight for the particular feature tuple, and
determining a per-feature weight deviation measure for the feature value based at least in part on the feature value and the per-feature weight for the feature value; and
determining the weighted feature tuple anomaly score based at least in part on the feature tuple anomaly score for the particular feature tuple and each per-feature weighted feature tuple anomaly score.

19. The computer program product of claim 15, wherein:
for a pth-level non-constant defined interaction level, each feature value combination comprisesp feature tuples.

20. The computer program product of claim 19, wherein each feature tuple is associated with an ensemble, an ensemble element, and an ensemble element enumeration.

21. The computer program product of claim 19, wherein each feature tuple is associated with an assigned weight value that is determined based on an output of processing one or more features of the feature tuple using a trained regression-based machine learning model.
